(19) United States
(12) Patent Application Publication
(10) Pub. No.: US 2002/0076503 A1
(43) Pub. Date: Jun. 20, 2002

(54) CLOTHING ARTICLE SUCH AS A WORKING OR PROTECTIVE GLOVE MADE FROM A TEXTILE SUPPORT

(76) Inventors: PATRICK BORREANI, VIENNE (FR); PIERRE VAILLE, CHASSIEU (FR)

Correspondence Address: WALL MARJAMA & BILINSKI, 101 SOUTH SALINA STREET, SUITE 400, SYRACUSE, NY, 13202, US

(21) Appl. No.: 09/462,406

(22) PCT Filed: Jul. 9, 1998
(86) PCT No.: PCT/FR98/01488

(30) Foreign Application Priority Data
Jul. 11, 1997 (FR) 97/09125

(51) Int. Cl. B05D 3/10

(52) U.S. Cl. 427/456

(57) ABSTRACT

The invention concerns a clothing article characterized in that: the textile support receives and adherence primer in the form of an aqueous calcium nitrate; the textile support with the adherence primer is subjected, entirely or partially, to a coating based on a foamed aqueous polymer; the foamed aqueous polymer only appears on the support outer part without going through the mesh so as not to produce contact with the corresponding part of the body.

The invention relates to the technical field of apparel, and more particularly to protective gloves, protective socks and other similar articles of clothing, obtained from a textile article, in particular a knitted one.

It is known to carry out specific operations on gloves in order to cover them, fully or in part, with a product that can protect them against soiling and chemical or mechanical attack, while being intended to comply with particular safety standards which depend on the type of work to be carried out. There are various ways of applying this protective product to the glove (coating, spraying, etc.). Similarly, this protection can be applied to knitted gloves made of synthetic or artificial, cellulose material.

This prior art may, for example, be illustrated by the teaching of patent U.S. Pat. No. 5,581,812. The protective product is generally a polyurethane in a solvent or a latex or a PVC, the use of which is not without risks. Further, as regards the nature of the protective product and the way in which it is applied to the glove, this product has a tendency to pass through the fibers or mesh, so that it is also found inside the glove, that is to say in direct contact with the user's skin. Gloves treated in this way are therefore uncomfortable, and risk causing allergy. It is also found that the gloves are no longer sufficiently ventilated.

The teaching of patent DD 287 743 may also be mentioned. This patent relates to a method of improving the stability against deterioration of composites made up of layers of closed PVC foam covered with a polyesterurethane protective layer. Composites of this type are used in particular for sportswear, for example motorcycle gloves, winter clothing and ball games. The intended object is to prevent the polyesterurethane layer from flaking and detaching from the PVC foam layer as the article ages.

U.S. Pat. No. 4,190,685 discloses an article of clothing, in particular a glove, which is highly resistant to chemicals, comprising a fabric underlayer, in particular precut to the shape of the article then covered with an inner layer of elastic elastomer, such as natural rubber derived from latex which adheres but does not penetrate, then covered with an outer layer of butyl rubber which may contain an inorganic filler. The lower layer of fabric provides the wearer with comfort while the combination of the inner layer, which has a high retention capacity for water vapor, and the outer layer, which is resistant to toxic chemical liquids, gives a high level of chemical resistance for long periods of up to 12 hours.

The problem which the invention addresses is to produce an article of clothing, in particular of the glove type, for handling and protection from a meshed textile support in which the outer face of the active part of the glove is treated in order to ensure accurate feel of thin objects while providing protection against soiling and liquids, and its object is to provide a flexible glove which has a comfortable textile feel, is durable and microporous for air, while being made hydrophobic and oleophobic for liquids.

Another object of the invention is to provide better safety due to the cut-resistance and non-slip properties of the gloves after coating with a protective product.

This object has been addressed by designing and developing an article of clothing of the glove type for handling and protection, obtained from a textile support, in particular a seamless knitted textile support, which is noteworthy in that:

an adhesion primer in the form of aqueous calcium nitrate is applied to the textile support;

some or all of the textile support with the adhesion primer undergoes a coating operation based on a foamed aqueous polymer;

the foamed aqueous polymer appears only on the outside of the support, without passing through the mesh so as not to make contact with the corresponding part of the body.

As a result of this combination of characteristics, a flexible, elastic, durable and comfortable article is obtained which is microporous for air but hydrophobic and oleophobic.

Advantageously, in order to achieve the stated object of providing a flexible and elastic foamed aqueous dispersion, use is made of a polymer, preferably an aliphatic polyetherurethane or polyesterurethane without free isocyanate groups, with between about 30 and 50% active substance, and with an elongation ratio of between about 430 and 1200%.

In order to achieve the stated object of providing a satisfactory foaming effect for the polymer and of improving the flexibility of the glove/coating composite, a detergent is added to the aqueous polymer dispersion in a range of about 2 to 8%.

The detergent is advantageously an aqueous solution of sodium salt of fatty acid glycol polyester sulfate, anionic, with between about 30 and 70% active substance.

Clearly, the active substance may be diluted as desired according to the base of the polymer used and the textile support employed.

Another problem which the invention addresses is to give the foam long-term stability. Such an object is achieved by adding an aqueous solution of ammonium stearate, anionic, with between about 30 and 60% active substance.

The use of a hydrotropic dispersant makes it possible to use a closed foam which, by definition, ought to be viscous, and to lower its viscosity in order to allow it to flow at the time of dipped coating, in particular in the way that will be described further on in the description.

In order to modify the flexibility of a glove treated according to the characteristics of the invention, it is possible to add water, although this should strictly not exceed about 7% so as not to lose the uniformity of the protective film.

It was found that the following standard mixture is particularly well-suited in terms of the object to be achieved. The aqueous dispersion comprises about:

100 parts polymer,

5 parts detergent,

5 parts stearate,

4 parts water,

0.7 part pigment,

0.5 part dispersant.

Clearly, this base mixture will be balanced according to each polymer, certain products being added on a case by case basis, depending on the supports and applications of the gloves.

In view of the selection of the base components and their preparation, the process of coating the glove or any other textile support will be carried out as follows:

the support to which the adhesion primer is applied beforehand is placed on a backing mold,

the backing mold is dipped in the aqueous dispersion,

a reciprocating movement is imparted to the backing mold,

the backing mold is removed,

the assembly is drained,

the assembly is turned over to get rid of the last drop or drops,

it is dried.

Without thereby departing from the scope of the invention, instead of taking a polyester or polyetherurethane base, it is possible to use an acrylic base, an acrylic-polyurethane mixture, an acrylovinyl, a natural or synthetic latex or any other foamable polymer.

The invention will be explained in detail below with the aid of the figures of the appended drawings, in which:

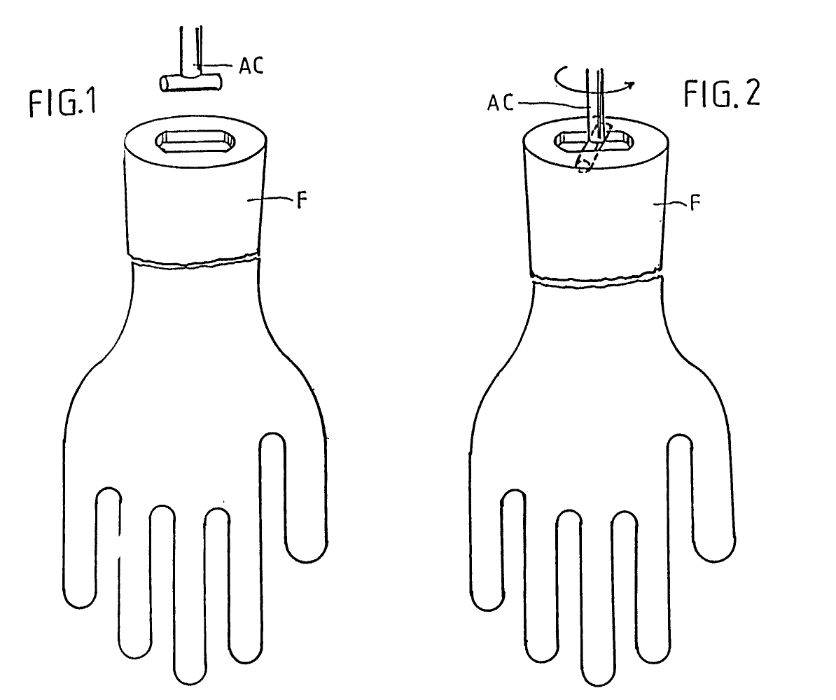

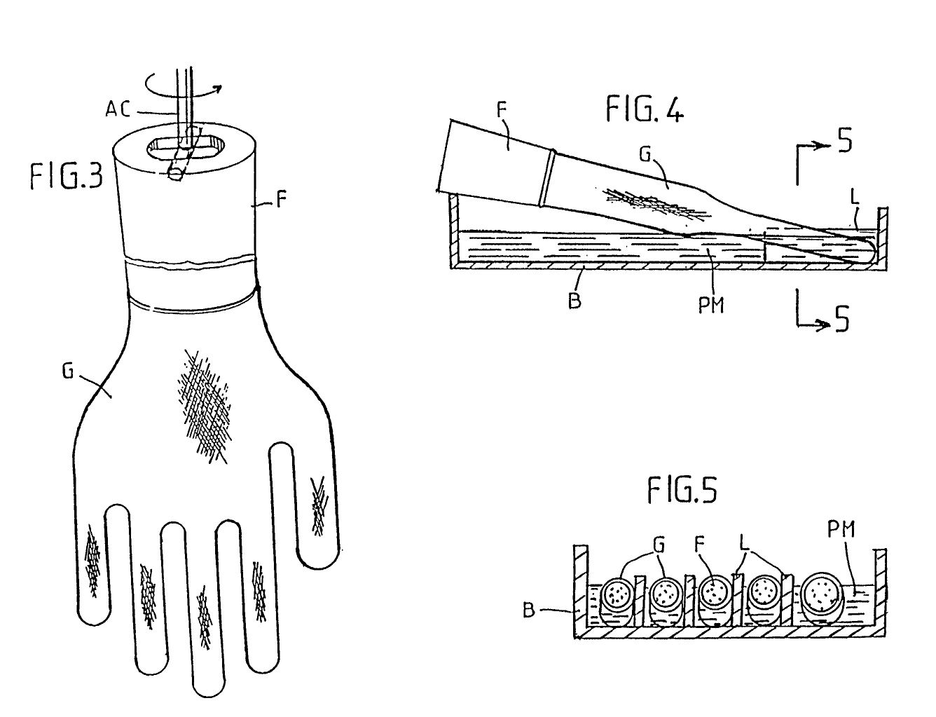

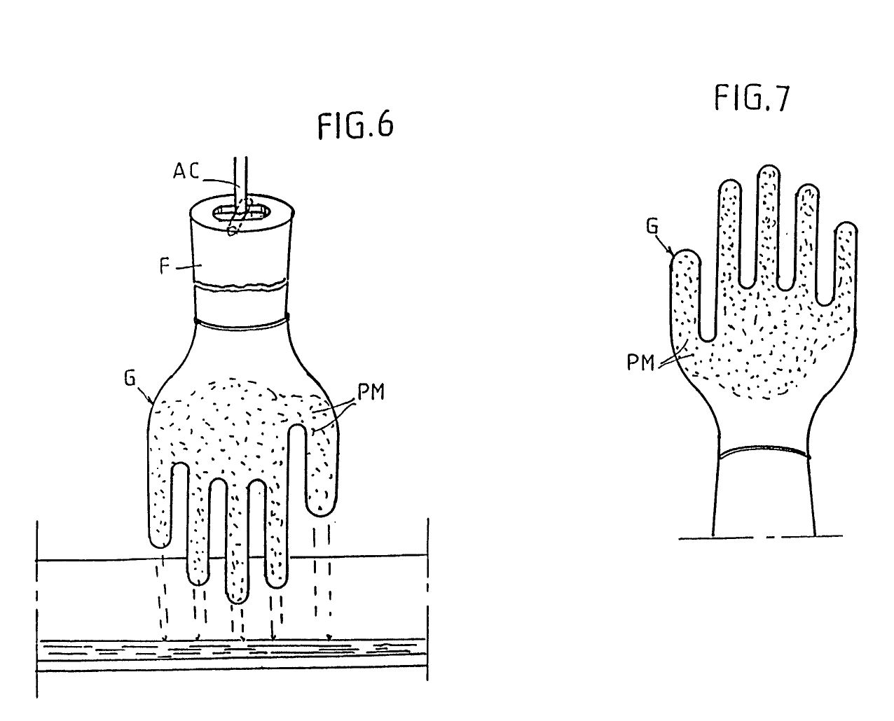

FIGS. 1, 2, 3, 4, 6 and 7 are schematic views showing the principal phases in the treatment process according to the invention.

FIG. 5 is a cross section taken on the line 5.5 in FIG. 4.

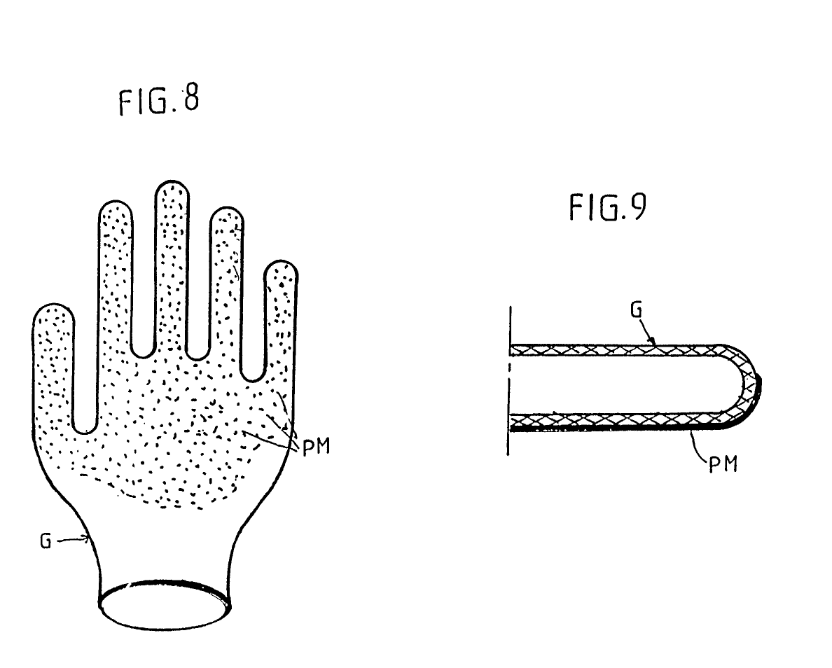

FIG. 8 shows a protective glove treated according to the characteristics of the invention.

FIG. 9 is a schematic sectional view on an enlarged scale taken on the line 9.9 in FIG. 8.

The figures of the drawings illustrate the invention as applied to a glove. It is clear that the invention can be applied to any other textile support, when the object is to coat a textile support fully or partly with a protective product, in particular for protecting against soiling and attack, in particular chemical or mechanical. For example, the textile support may consist of a footwear article such as a sock. The textile support itself advantageously results from the knitting of natural or artificial or synthetic fibers.

According to one fundamental characteristic of the invention, the textile support is coated with a protective product (P) in the form of a polymer, preferably polyurethane, foamed beforehand as a closed foam. To this end, and in order to produce this foam, the invention uses an aqueous dispersion of an aliphatic polyetherurethane or polyesterurethane, without free isocyanate groups, with between about 30 and 50% active substance. In order to obtain considerable flexibility, the elongation ratio should be between 430 and 1200% elongation. A medium value regarded as satisfactory is 820%. This foamable polymer constitutes the basis of the protective product according to the invention.

This base solution may advantageously be supplemented with various components, which will be selected and introduced in a variable amount, depending on the nature of the textile support to be treated and the applications envisaged. This base solution, namely the foamable polymer, is advantageously supplemented with a wetting detergent, namely an aqueous solution of sodium salt of fatty acid glycol polyester sulfate, anionic, with between about 30 and 70% active substance. The active substance may be diluted as desired according to the base of the polymer and the textile support employed. This detergent makes it possible to foam the polymer and add considerable flexibility to the support or textile article treated in this way. In this regard, it has been found advantageous to adopt a 2% minimum in order to obtain a foaming effect, and an 8% maximum in order not to have too fatty an effect.

It is also possible to add an aqueous solution of ammonium stearate, anionic, with between 30 and 60% active substance to the foamable base solution. As before, the active substance is tailored according to the base of the polymer and the textile support used. The effect of the ammonium stearate is to give the foam the requisite long-term stability. It has been found advantageous to add a minimum amount of 4% which may be increased to 6%. As regards the detergent and the stearate, it has been found advantageous to use the following ratio: 5% detergent to 5% stearate. Clearly, if it is desired to modify flexibility, extent of foaming and stability of the foam, the ratio will need to be changed accordingly.

Again with the aim of modifying flexibility, it is possible to add water, although this should strictly not exceed about 5% so as not to lose the uniformity of the protective film.

In view of the considerations above, assuming a foamed polymer representing 100 parts, the following base mixture may be adopted:

100 parts polymer,

5 parts detergent,

5 parts stearate,

4 parts water,

0.7 part pigment,

0.5 part dispersant.

In order to obtain the desired foamed effect, a beating operation or an aerating operation may be carried out on the base mixture.

The greater the foam density of the product (P) is, calculated in grams per liter, the lower its viscosity will be.

The difficulty is to reverse the phenomenon, that is to say to obtain low viscosity with low density, and to do so by adding a dispersant.

By way of indicative but entirely nonlimiting example, for a foam density of 500 g/l, it has been found beneficial to adjust the viscosity to 60+/−5 dpa.s, measured for example with a HAAKE type 808.0758, viscotester VT 02 viscometer. It will be recalled, however, that the density and viscosity need to be balanced according to each support and each type of polymer by modifying the amount of at least one of the elements of the base mixture indicated above. In this regard, it can be found that a foam density of between 400 g/l and 700 g/l gives satisfactory results. More particularly, a density of 500 g/l with a viscosity of 1800 mpa.s proves particularly advantageous.

As will be indicated further on in the description, in particular when the coating is being carried out, although the foam is given consistency because of its density it should have a low viscosity in order to fall slowly down the glove uniformly after a specific time.

According to another important characteristic of the invention, it has been found important and necessary to use an adhesion primer, in view of the difficulty of working with a foamed polymer, and the difficulty of achieving a good compromise between viscosity and density, the purpose being to obtain good bonding of the product to the textile support, although without going through the mesh of this support. This adhesion primer may consist of a saline or acid solution, in particular calcium nitrate in aqueous medium without adding any volatile solvent for health reasons. The water/nitrate combination increases the hydrophilicity of the fibers, in particular synthetic fibers, and allows better bonding by trapping the foam inside the fibers, but without going through them.

To that end, before the glove or other textile article is coated and shaped, it is soaked in the saline or acid solution for a period of about at most 10 min.

The glove is then wrung before shaping in order to prevent excess water from flowing off after dipping in the foamed polymer, as will be explained, thus preventing the formation of coagulated stalactites along the fingers.

The effect and purpose of this adhesion primer is therefore to bond the polymer to the fiber, enhancing the abrasion-resistance properties, while preventing the foam from going through the mesh. Further, this adhesion primer prevents the coating, after soaking, from moving over the glove by capillary action, thus making it possible to obtain precise contours as indicated below. This adhesion is retained even after washing with water or solvents.

Reference will now be made to FIGS. 1, 2, 3, 4, 5, 6 and 7 of the drawing which, in particular, show the process for treating a glove (G). Before the operation of coating proper in the foamed polymer, the glove is dipped in the nitrate solution in order to create the adhesion primer, as indicated above. After wringing, the still-wet glove is placed on a mold (F) corresponding to a right or left hand, this being done for different sizes. As is well known, these molds (F) can be made of porcelain (FIG. 1). It should be noted that each mold can be fitted to means of connection (AC) and movement in order to be brought to the treatment area, that is to say the foam polymer bath. For example, each backing mold (F) may engage in an oblong hole (F1) with a pivoting hook in order to hang the backing mold (FIGS. 1 and 2).

Each backing mold thus fitted with the glove and the adhesion primer is dipped in the tank or tanks (B) holding the foamed polymer (PM). By way of entirely nonlimiting example, the tanks are at least 4 cm deep and about 30 cm long, as viewed in the dipping direction. Under these conditions, the backing mold is inclined by about 10° relative to the horizontal (FIG. 4) when it is placed in the tank or tanks (B). It is then found that only some of the glove, namely its inner active face (corresponding to the palm of the hand) is subjected to the action of the pushed [sic] polymer (PM). The fingertips touch the bottom bearing against the opposite wall of the tank.

Without thereby departing from the scope of the invention, it is not inconceivable to dip the backing mold partially in a substantially horizontal plane and to move it in translation.

The bottom of the tank advantageously has vertical tongues (L), especially in the zone where the fingers of the glove press, which act as spacers and are intended to engage with the gap between each of the fingers of glove. These arrangements make it possible for the foamed polymer to spread uniformly between and around the lower half-part of each finger. Specifically, the backing mold (F) is subjected by some suitable known means, manual or mechanical, to a right-to-left pivoting motion then vertical withdrawal in an elliptical movement, while tending to “surf” over the foamed product. It is therefore found that, intentionally, only the lower half-part of the fingers, thumb and palm become coated with the foamed product.

It will be recalled, as indicated above, that it is entirely feasible to carry out complete coating of the textile support according to the characteristics of the invention.

The glove thus treated is then held suspended in a vertical position, still on its backing mold (F) in order to be drained. The product which flows off is recovered. As indicated above, the foamed product falls slowly and uniformly along the glove. After 15 to 20 min, the film breaks naturally between the fingers and this smooth flow ends with dripping at the fingertips. When the last drop arrives, all that needs to be done is invert the backing mold in order to distribute this drop uniformly at the corresponding fingertips.

The glove thus treated is then dried in free air then, optionally, stored at a temperature of no more than 90° C. for a period of about 15 to 20 min.

It should be noted that, depending on the type of fiber, in particular for synthetic fibers, a half an hour of rinsing is needed to remove all traces of nitrate remaining on the glove. Otherwise, the glove may stay quite stiff. It should be noted that, in this case, it is expedient to dip the backing mold directly with the coated glove in water, which allows the glove to be removed more easily, and the enameled backing mold can be re-used after cooling. By cooling rapidly, the coating will solidify and bond immediately and become inert.

Further, as already indicated above, instead of using a polyester or polyetherurethane base, it is not inconceivable to use an acrylic base, an acrylicpolyurethane mixture, an acrylovinyl, a natural or synthetic latex or some other foamable polymer. Similarly, depending on the nature of the textile article to be treated and the quality which it is desired to obtain, in particular according to the application envisaged, it will be enough to add certain components to the base mixture. Certain technical solutions which may be envisaged will be indicated below, according to the properties of the article which it is desired to obtain.

In the case of a support which is too hydrophilic, a fluorocarbon is added in a proportion of about 2 to 5% of the weight of the base mixture.

In order to enhance the smoothe appearance of the surface, about 2 to 3% glycerol or an aqueous emulsion of a modified methyl polysiloxane is added.

In order to add weight to the coating, conventional fillers such as talc, chalk, kaolin, barytin, etc. are added.

In order to fire-proof the article, antimony oxides, alumina [sic] oxides, decabromodiphenyl oxides, etc. are added as filler.

In order to increase the viscosity of the foam, about 2 to 5 g/kg of a thickener paste based on sodium polyacrylate, anionic, with 13% +/2% dry substance is added.

In order to reduce the foam active substance, water is added.

In order to increase the degree of whiteness, titanium oxide is added.

In order to reduce viscosity, a dispersant is added.

The advantages can be seen clearly from the description, and in particular it is to be emphasized and recalled that the glove obtained, or other article of clothing resulting from a meshed textile support, is covered in its active part, in particular, with a protective product in the form of a closed mechanical foam of aqueous polyurethane with low density and low viscosity, in combination with an adhesion primer, so that the product does not go through the mesh and come into contact with the hand or other part of the body.

The foam is external and not covered by any fibers or extra textile support, and is in direct contact with the outside.

The glove is also found to keep its natural flexibility while further being microporous, breathable, non-slip, washable and vibration-proof.

1. An article of clothing of the glove type for handling and protection, obtained from a textile support, wherein:
an adhesion primer in the form of aqueous calcium nitrate is applied to the textile support;
some or all of the textile support with the adhesion primer undergoes a coating operation based on a foamed aqueous polymer;
the foamed aqueous polymer appears only on the outside of the support, without passing through the mesh so as not to make contact with the corresponding part of the body.

2. The article of clothing as claimed in claim 1, wherein the polymer is preferably an aliphatic polyetherurethane or polyesterurethane without free isocyanate groups, with between about 30 and 50% active substance, and with an elongation ratio of between about 430 and 1200%, preferably 820%.

3. The article of clothing as claimed in claim 1, wherein the density of the foam is between 400 g/l and 700 g/l, preferably 500 g/l, with a viscosity of between 1500 and 3000 mpa.s, preferably 1800 mPa.s.

4. The article of clothing as claimed in claim 1, wherein the foamed aqueous polymer is supplemented by a detergent, in a range of about 2 to 8%.

5. The article of clothing as claimed in claim 4, wherein the detergent is an aqueous solution of sodium salt of fatty acid glycol polyester sulfate, anionic, with between about 30 and 70% active substance.

6. The article of clothing as claimed in claim 1, wherein the foamed aqueous polymer is supplemented with an aqueous solution of ammonium stearate, anionic, with between about 30 and 60% active substance.

7. The article of clothing according to claim [lacuna], wherein the foamed aqueous polymer is supplemented by a dispersant.

8. The article of clothing as claimed in claim 1, wherein the foamed aqueous polymer is supplemented with water.

9. The article of clothing as claimed in claim 1, wherein the foamed aqueous polymer comprises about:
100 parts polymer,
5 parts detergent,
5 parts stearate,
4 parts water,
0.7 part pigment,
0.5 part dispersant.

10. A process for treating an article of clothing, as claimed in one of claims 1 to 9, wherein:
the support to which the adhesion primer is applied is placed on a backing mold,
the backing mold is dipped in the aqueous dispersion,
a reciprocating movement is imparted to the backing mold,
the backing mold is removed,
the assembly is drained,
the assembly is turned over to get rid of the last drop or drops,
it is dried.
